(19) United States
(12) Patent Application Publication
(10) Pub. No.: US 2013/0144524 A1
(43) Pub. Date: Jun. 6, 2013

(54) DOUBLE-HUB INDEXING IN LOCATION SERVICES

(71) Applicant: Microsoft Corporation, Redmond, WA (US)

(72) Inventors: Ittai Abraham, San Francisco, CA (US); Daniel Delling, Mountain View, CA (US); Andrew V. Goldberg, Emerald Hills, CA (US); Renato F. Werneck, San Francisco, CA (US); Amos Fiat, Tel Aviv (IL)

(73) Assignee: Microsoft Corporation, Redmond, WA (US)

(21) Appl. No.: 13/753,540

(22) Filed: Jan. 30, 2013

Related U.S. Application Data
(63) Continuation-in-part of application No. 13/287,154, filed on Nov. 2, 2011.
Application No. 13/287,154 is a continuation-in-part of application No. 13/076,456, filed on Mar. 31, 2011.

(51) Int. Cl. G01C 21/34

(52) U.S. Cl. CPC G01C 21/3446
USPC 701/527; 701/400; 701/540; 701/533

(57) ABSTRACT

Techniques using double-hub indexing are provided that can provide efficient solutions to location-based services that depend on two query points. Such services include point of interest (POI) prediction, best via point, and ride sharing. Double-hub indexing builds on the hub labels (HL) algorithm for computing shortest paths on road networks. It associates two labels (forward and backward) to each vertex v in the network. Each label comprises a set of hubs (other vertices), together with the distances between these hubs and v. The set of labels have a cover property that for any two vertices s and t, their labels intersect in at least one hub that is on the shortest s-t path.

### CROSS-REFERENCE TO RELATED APPLICATIONS

This application is a continuation-in-part of pending U.S. patent application Ser. No. 13/287,154, “SHORTEST PATH DETERMINATION IN DATABASES,” filed Nov. 2, 2011, which is a continuation-in-part of pending U.S. patent application Ser. No. 13/076,456, “HUB LABEL BASED ROUTING IN SHORTEST PATH DETERMINATION,” filed Mar. 31, 2011, the entire contents of which are hereby incorporated by reference.

### BACKGROUND

Existing computer programs known as road-mapping programs provide digital maps, often complete with detailed road networks down to the city-street level. Typically, a user can input a location and the road-mapping program will display an on-screen map of the selected location. Several existing road-mapping products typically include the ability to calculate a best route between two locations. In other words, the user can input two locations, and the road-mapping program will compute the travel directions from the source location to the destination location. The directions are typically based on distance, travel time, and certain user preferences, such as a speed at which the user likes to drive, or the degree of scenery along the route. Computing the best route between locations may require significant computational time and resources.

Some road-mapping programs compute shortest paths using variants of a well known method attributed to Dijkstra. Note that in this sense “shortest” means “least cost” because each road segment is assigned a cost or weight not necessarily directly related to the road segment's length. By varying the way the cost is calculated for each road, shortest paths can be generated for the quickest, shortest, or preferred routes. Dijkstra's original method, however, is not always efficient in practice, due to the large number of locations and possible paths that are scanned. Instead, many known road-mapping programs use heuristic variations of Dijkstra's method.

Dijkstra's algorithm can find shortest paths in essentially linear time, but is still too slow for many applications on large networks. This has motivated the study of acceleration techniques, which use information gathered during a preprocessing stage to speed up queries. During the preprocessing phase, the graph or map is subject to an off-line processing such that later real time queries between any two destinations on the graph can be made more efficiently. Known examples of preprocessing algorithms use geometric information, hierarchical decomposition, and A* search combined with landmark distances.

One speedup technique is sparsification, which uses the fact that road networks have strong hierarchies. Algorithms such as highway hierarchies (HH), contraction hierarchies (CH), and reach based routing (RE) run a bidirectional version of Dijkstra's algorithm, but prune unimportant vertices as the searches move farther from the source and the target. To ensure optimality, the preprocessing stage measures the importance of each vertex according to a mathematical definition. Another speedup technique is transit node routing (TNR). During preprocessing, it computes a large table with the distances between the most important vertices in the graph, enabling long-range queries to be answered with a few table lookups. Local queries still use a standard Dijkstra-based algorithm, such as CH. By combining sparsification with goal-direction techniques (such as A* search or arc flags), which guide the search towards the target using information gathered during preprocessing, further speedups are possible.

Thus, given a source and a destination, the fastest techniques can find the exact shortest path in a road network with tens of millions of vertices in a millisecond or less. This is achieved by preprocessing the network for a few minutes (or hours) to generate auxiliary data that speeds up queries. Any such technique can be implemented as an external distance oracle, a standalone module that runs outside the database but can be called from SQL to compute the distance or retrieve the shortest path between two points.

Unfortunately, implementing these speedup techniques in various applications is complex. For example, translating these speedup techniques to SQL relies on sophisticated data structures (such as graphs and priority queues) that cannot be implemented nearly as efficiently in databases.

### SUMMARY

Techniques using double-hub indexing are provided to provide efficient solutions to location-based services that depend on two query points. Such services include best via point, ride sharing, and point of interest (POI) prediction.

In an implementation, double-hub indexing builds on the hub labels (HL) algorithm for computing shortest paths on road networks. It associates two labels (forward and backward) to each vertex v in the network. Each label comprises a set of hubs (other vertices), together with the distances between these hubs and the vertex v. The set of labels have a cover property that for any two vertices s and t, their labels intersect in at least one hub that is on the shortest s-t path.

In an implementation, labels can be used to solve the best via point problem efficiently. The double-hub indexing techniques can be applied to other applications as well, such as ride sharing (matching riders to drivers) and POI prediction (finding a point of interest that is “ahead” of a driver during an ongoing journey). More generally, it can speed up applications that evaluate pairs of shortest paths with a common endpoint.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 shows an example of a computing environment in which aspects and embodiments may be potentially exploited;

FIG. 2 is an operational flow of an implementation of a method using a labeling technique for determining a shortest path between two locations;

FIG. 3 is an operational flow of an implementation of a method using a hub based labeling technique for determining a shortest path between two locations;

FIG. 4 is an operational flow of an implementation of a method for pruning labels in determining a shortest path between two locations;

FIG. 5 is an operational flow of an implementation of a method for using shortest path covers;

FIG. 6 is an operational flow of an implementation of a method for accelerating hub label preprocessing using faster shortest path covers;

FIG. 7 is an operational flow of an implementation of a method for accelerating hub label preprocessing using faster label generation;

FIG. 8 is an operational flow of an implementation of a method for label compression in determining a shortest path between two locations;

FIG. 9 is an operational flow of an implementation of a method for accelerating queries using a partition oracle in determining a shortest path between two locations;

FIG. 10 is an operational flow of an implementation of a method using a hub based labeling technique with a relational database for determining a shortest path between two locations;

FIG. 11 is an operational flow of an implementation of a method using a hub based labeling technique with tables and a relational database for determining a distance between two locations;

FIG. 12 is an operational flow of an implementation of a method using a hub based labeling technique using tables with a relational database for determining a shortest path between two locations;

FIG. 13 is an operational flow of an implementation of a method using a hub based labeling technique with a relational database for determining a via point solution;

FIG. 14 is an operational flow of an implementation of a method using a double-hub indexing technique for determining a best via path (e.g., shortest via path) between two locations;

FIG. 15 is an operational flow of another implementation of a method using a double-hub indexing technique for determining a best via path (e.g., shortest via path) between two locations;

FIG. 16 is an operational flow of an implementation of a method using a double-hub indexing technique for determining a ride sharing solution;

FIG. 17 is an operational flow of an implementation of a method using a double-hub indexing technique for POI prediction; and

FIG. 18 shows an exemplary computing environment.

### DETAILED DESCRIPTION

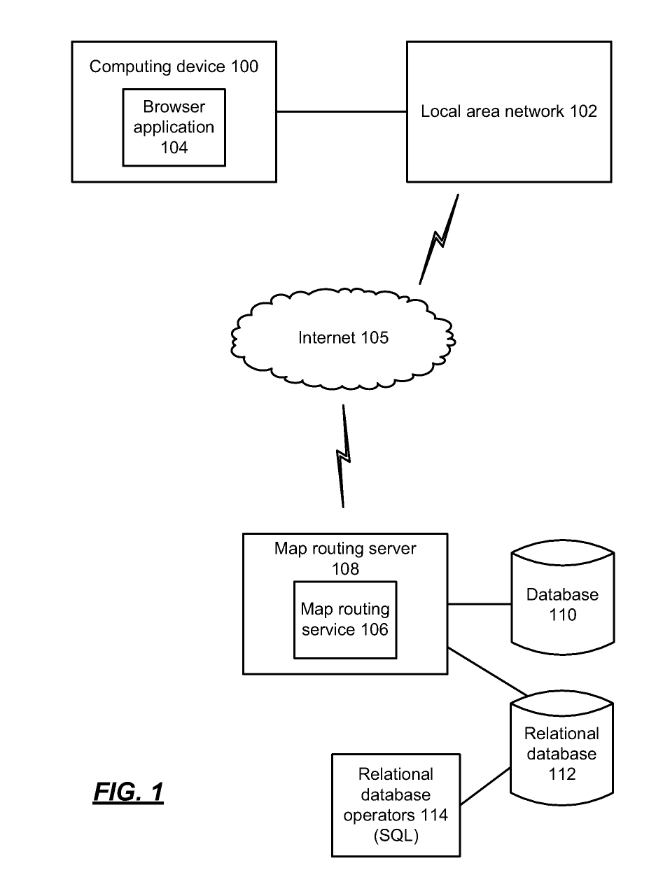

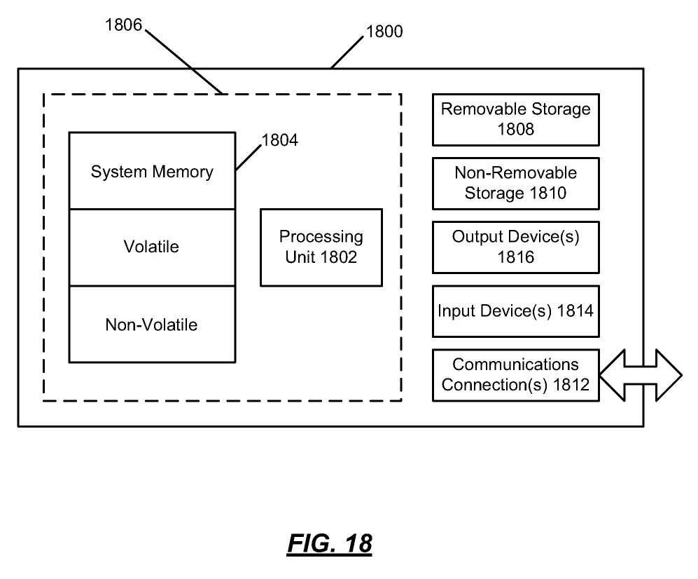

FIG. 1 shows an example of a computing environment in which aspects and embodiments may be potentially exploited. A computing device 100 includes a network interface card (not specifically shown) facilitating communications over a communications medium. Example computing devices include personal computers (PCs), mobile communication devices, etc. In some implementations, the computing device 100 may include a desktop personal computer, workstation, laptop, PDA (personal digital assistant), smart phone, cell phone, or any WAP-enabled device or any other computing device capable of interfacing directly or indirectly with a network. An example computing device 100 is described with respect to the computing device 1800 of FIG. 18, for example.

The computing device 100 may communicate with a local area network 102 via a physical connection. Alternatively, the computing device 100 may communicate with the local area network 102 via a wireless wide area network or wireless local area network media, or via other communications media. Although shown as a local area network 102, the network may be a variety of network types including the public switched telephone network (PSTN), a cellular telephone network (e.g., 3G, 4G, CDMA, etc), and a packet switched network (e.g., the Internet). Any type of network and/or network interface may be used for the network.

The user of the computing device 100, as a result of the supported network medium, is able to access network resources, typically through the use of a browser application 104 running on the computing device 100. The browser application 104 facilitates communication with a remote network over, for example, the Internet 105. One exemplary network resource is a map routing service 106, running on a map routing server 108. The map routing server 108 hosts a database 110 of physical locations and street addresses, along with routing information such as adjacencies, distances, speed limits, and other relationships between the stored locations.

A user of the computing device 100 typically enters start and destination locations as a query request through the browser application 104. The map routing server 108 receives the request and produces a shortest path among the locations stored in the database 110 for reaching the destination location from the start location. The map routing server 108 then sends that shortest path back to the requesting computing device 100. Alternatively, the map routing service 106 is hosted on the computing device 100, and the computing device 100 need not communicate with a local area network 102.

In an implementation, the database 110 may comprise a relational database and may store relational database operators (such as in SQL) that can be used to efficiently find shortest paths and nearest neighbors on road networks, as described further herein. Alternately, a separate relational database 112 may store relational database operators 114 and use them as described further herein.

The point-to-point (P2P) shortest path problem is a classical problem with many applications. Given a graph G with non-negative arc lengths as well as a vertex pair (s,t), the goal is to find the distance from s to t. The graph may represent a road map, for example. For example, route planning in road networks solves the P2P shortest path problem. However, there are many uses for an algorithm that solves the P2P shortest path problem, and the techniques, processes, and systems described herein are not meant to be limited to maps.

Thus, a P2P algorithm that solves the P2P shortest path problem is directed to finding the shortest distance between any two points in a graph. Such a P2P algorithm may comprise several stages including a preprocessing stage and a query stage. The preprocessing phase may take as an input a directed graph. Such a graph may be represented by G=(V,A), where V represents the set of vertices in the graph and A represents the set of edges or arcs in the graph. The graph comprises several vertices (points), as well as several edges. The preprocessing phase may be used to improve the efficiency of a later query stage, for example.

During the query phase, a user may wish to find the shortest path between two particular nodes. The origination node may be known as the source vertex, labeled s, and the destination node may be known as the target vertex labeled t. For example, an application for the P2P algorithm may be to find the shortest distance between two locations on a road map. Each destination or intersection on the map may be represented by one of the nodes, while the particular roads and highways may be represented by an edge. The user may then specify their starting point s and their destination t.

Thus, to visualize and implement routing methods, it is helpful to represent locations and connecting segments as an abstract graph with vertices and directed edges. Vertices correspond to locations, and edges correspond to road segments between locations. The edges may be weighted according to the travel distance, transit time, and/or other criteria about the corresponding road segment. The general terms “length” and “distance” are used in context to encompass the metric by which an edge's weight or cost is measured. The length or distance of a path is the sum of the weights of the edges contained in the path. For manipulation by computing devices, graphs may be stored in a contiguous block of computer memory as a collection of records, each record representing a single graph node or edge along with associated data.

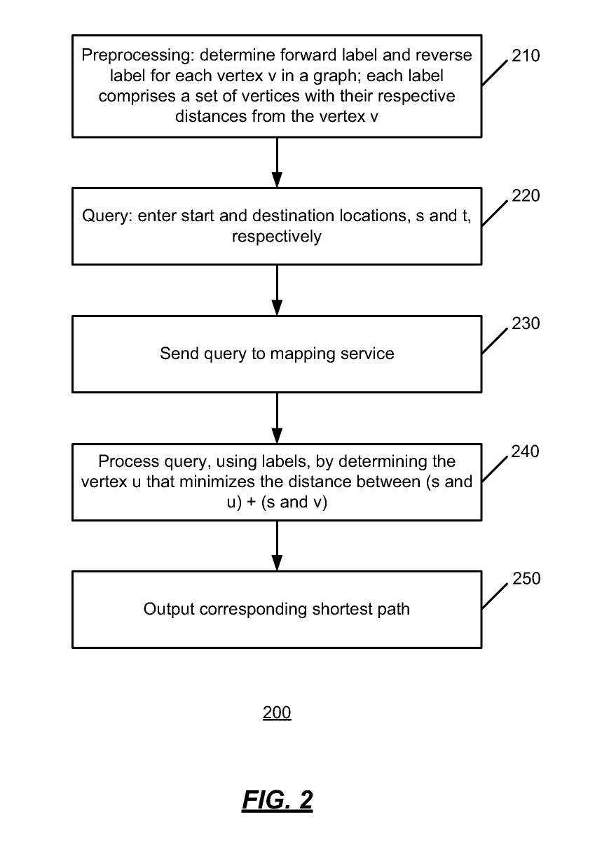

A labeling technique may be used in the determination of point-to-point shortest paths. FIG. 2 is an operational flow of an implementation of a method 200 using a labeling technique for determining a shortest path between two locations. A label for a vertex v is a set of hubs to which the vertex v stores a direct connection, and any two vertices s and t share at least one hub on the shortest s-t path.

During the preprocessing stage, at 210, the labeling algorithm determines a forward label L_{f}(v) and a reverse label Lᵣ(v) for each vertex v. Each label comprises a set of vertices w, together with their respective distances from the vertex v (in L_{f}(v)) or to the vertex v (in Lᵣ(v)). Thus, the forward label comprises a set of vertices w, together with their respective distances d(v,w) from v. Similarly, the reverse label comprises a set of vertices u, each with its distance d(u,v) to v. A labeling is valid if it has the cover property that for every pair of vertices and t, L_{f}(s)∩Lᵣ(t) contains a vertex u on a shortest path from s to t (i.e., for every pair of distinct vertices s and t, L_{f}(s) and Lᵣ(t) contain a common vertex u on a shortest path from s to t).

At query time, at 220, a user enters start and destination locations, s and t, respectively (e.g., using the computing device 100), and the query (e.g., the information pertaining to the s and t vertices) is sent to a mapping service (e.g., the map routing service 106) at 230. The s-t query is processed at 240 by finding the vertex uεL_{f}(s)∩Lᵣ(t) that minimizes the distance (dist(s,u)+dist(u,t)). The corresponding path is outputted to the user at 250 as the shortest path.

In an implementation, a labeling technique may use hub based labeling. Recall the preprocessing stage of a P2P shortest path algorithm may take as input a graph G=(V,A), with |V|=n, |A|=m, and length £(a)>0 for each arc a. The length of a path P in G is the sum of its arc lengths. The query phase of the shortest path algorithm takes as input a source s and a target t and returns the distance dist(s,t) between them, i.e., the length of the shortest path between s and t in the graph G. As noted above, the standard solution to this problem is Dijkstra's algorithm, which processes vertices in increasing order of distance from s. For every vertex v, it maintains the length d(v) of the shortest s-v path found so far, as well as the predecessor p(v) of v on the path. Initially, d(s)=0, d(v)=∞ for all other vertices, and p(v)=null for all v. At each step, a vertex v with minimum d(v) value is extracted from a priority queue and scanned: for each arc (v,w)εA, if d(v)+l(v,w)<d(w), set d(w)=d(v)+l(v,w) and p(v)=w. The algorithm terminates when the target t is extracted.

Preprocessing enables much faster exact queries on road networks. The known contraction hierarchies (CH) algorithm, in particular, is based on the notion of shortcuts. The shortcut operation deletes (temporarily) a vertex v from the graph; then, for any neighbors u,w of v such that (u,v)·(v,w) is the only shortest path between u and w, CH adds a shortcut arc (u,w) with l(u,w)=l(u,v)+l(v,w), thus preserving the shortest path information.

The CH preprocessing routine defines a total order among the vertices and shortcuts them sequentially in this order, until a single vertex remains. It outputs a graph G⁺=(V,A∪A⁺) (where A⁺ is the set of shortcut arcs created), as well as the vertex order itself. The position of a vertex v in the order is denoted by rank(v). As used herein, G↑ refers to the graph containing only upward arcs and G↓ refers to the graph containing only downward arcs. Accordingly, G↑ may be defined=(V,A↑) by A↑={(v,w)εA∪A⁺: rank(v)<rank(w)}. Similarly, A↓ may be defined={(v,w)εA∪A⁺: rank(v)>rank(w)} and G↓ defined=(V,A∪A↓).

During an s-t query, the forward CH search runs Dijkstra from s in G↓, and the reverse CH search runs reverse Dijkstra from t in G↓. These searches lead to upper bounds dₛ(v) and dₜ(v) on distances from s to v and from v to t for every vεV. For some vertices, these estimates may be greater than the actual distances (and even infinite for unvisited vertices). However, as is known, the maximum-rank vertex u on the shortest s-t path is guaranteed to be visited, and v=u will minimize the distance dₛ(v)+dₜ(v)=dist(s,t).

Queries are correct regardless of the contraction order, but query times and the number of shortcuts added may vary greatly. For example, in an implementation, the priority of a vertex u is set to 2ED(u)+CN(u)+H(u)+5L(u), where ED(u) is the difference between the number of arcs added and removed (if u were shortcut), CN(u) is the number of previously contracted neighbors, H(u) is the number of arcs represented by the shortcuts added, and L(u) is the level u would be assigned to. L(u) is defined as L(v)+1, where v is the highest-level vertex among all lower-ranked neighbors of u in G⁺; if there is no such v, L(u)=0.

A labeling algorithm uses the concept of labels. Every point has a set of hubs: this is the label (along with the distance from the point to all those hubs). For example, for two points (the source and the target), there are two labels. The hubs are determined that appear in both labels, and this information is used to find the shortest distance.

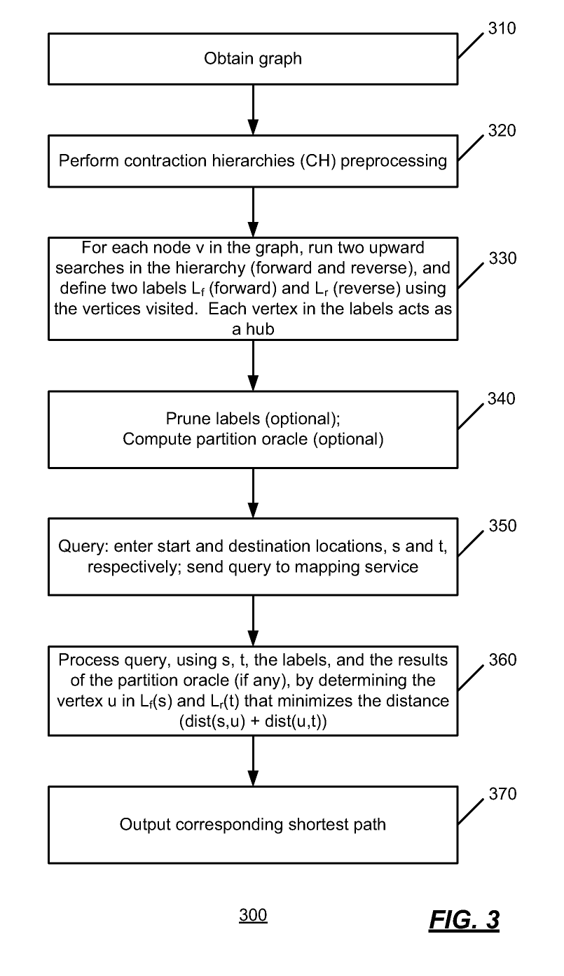

FIG. 3 is an operational flow of an implementation of a method 300 using a hub based labeling technique for determining a shortest path between two locations. In an implementation, the hub based labeling technique uses two stages: a preprocessing stage and a query stage. Finding the hubs is performed in the preprocessing stage, and finding the intersecting hubs (i.e., the common hubs shared by the source and the target) is performed in the query stage.

During the preprocessing stage, at 310, a graph is obtained, e.g., from storage or from a user. At 320, CH preprocessing is performed. At 330, for each node v of the graph, a search is run in the hierarchy, only looking upwards. The result is the set of nodes in the forward label. The same is done for reverse labels. For each vertex v define two labels: L_{f}(v) (forward) is the set of pairs (w, dist(v,w)) for all visited vertices w in the forward upward search, and Lᵣ(v) (reverse) is the set of pairs (u, dist(u,v)) for all visited vertices u in the reverse upward search. Labels have the cover property that for every pair (s,t), there is a vertex v such that vεP(s,t) (v belongs to the shortest path), vεL_{f}(s), and vεLᵣ(t). Each vertex in the labels for v acts as a hub. At 340, labels may be pruned, and a partition oracle may be computed, as described further herein.

Thus, the technique builds labels from CH searches. The CH preprocessing is enhanced to make labels smaller. More particularly, with respect to building a label, in an implementation, given s and t, consider the sets of vertices visited by the forward CH search from s and the reverse CH search from t. CH works because the intersection of these sets contains the maximum-rank vertex u on the shortest s-t path. Therefore, a valid label may be obtained by defining for every v, L_{f}(v) and Lᵣ(v) to be the sets of vertices visited by the forward and reverse CH searches from v.

In an implementation, to represent labels for allowing efficient queries, a forward label L_{f}(v) may comprise: (1) a 32-bit integer Nᵥ representing the number of vertices in the label, (2) a zero-based array Iᵥ with the (32-bit) IDs (identifiers) of all vertices in the label, in ascending order, and (3) an array Dᵥ with the (32-bit) distances from v to each vertex in the label. Lᵣ labels are symmetric to that described for L_{f} labels. Note that vertices appear in the same order in Iᵥ and Dᵥ: Dᵥ[i]=dist(v, Iᵥ[i]).

At query time, at 350, a user enters start and destination locations, s and t, respectively, and the query is sent to a mapping service. The s-t query is processed at 360, using s, t, the labels, and the results of the partition oracle (if any), by determining the vertex uεL_{f}(s)∩Lᵣ(t) (i.e., the vertex u in L_{f}(s) and L_{f}(t)) that minimizes the distance (dist(s,u)+dist(u,t)). The corresponding shortest path is outputted to the user at 370.

More particularly, given s and t, the hub based labeling technique picks, among all vertices wεL_{f}(s)∩Lᵣ(t), the one minimizing dₛ(w)+dₜ(w)=dist(s,w)+dist(w,t). Because the Iᵥ arrays are sorted, this can be done with a single sweep through the labels. Arrays of indices iₛ and iₜ (initially zero) and a tentative distance μ (initially infinite) are maintained. At each step, Iₛ[iₛ] is compared with Iₜ[iₜ]. If these IDs are equal, a new w has been found in the intersection of the labels, so a new tentative distance Dₛ[iₛ]+Dₜ[iₜ] is computed, μ is updated if necessary, and both iₛ and iₜ are incremented. If the IDs differ, either iₛ is incremented (if Iₛ[iₛ]<Iₜ[iₜ]) or iₜ is incremented (if^{I}ₛ[iₛ]>Iₜ[iₜ]). The technique stops when either iₛ=Nₛ or iₜ=Nₜ, and then μ is returned.

The technique accesses each array sequentially, thus minimizing the number of cache misses. Avoiding cache misses is also a motivation for having Iᵥ and Dᵥ as separate arrays: while almost all IDs in a label are accessed, distances are only needed when IDs match. Each label is aligned to a cache line. Another improvement is to use the highest-ranked vertex as a sentinel by assigning ID n to it. Because this vertex belongs to all labels, it will lead to a match in every query; it therefore suffices to test for termination only after a match. In addition, the distance to the sentinel may be stored at the beginning of the label, which enables a quick upper bound on the s-t distance to be obtained.

The hub based labeling technique may be improved using a variety of techniques, such as label pruning, shortest path covers, label compression, and the use of a partition oracle.

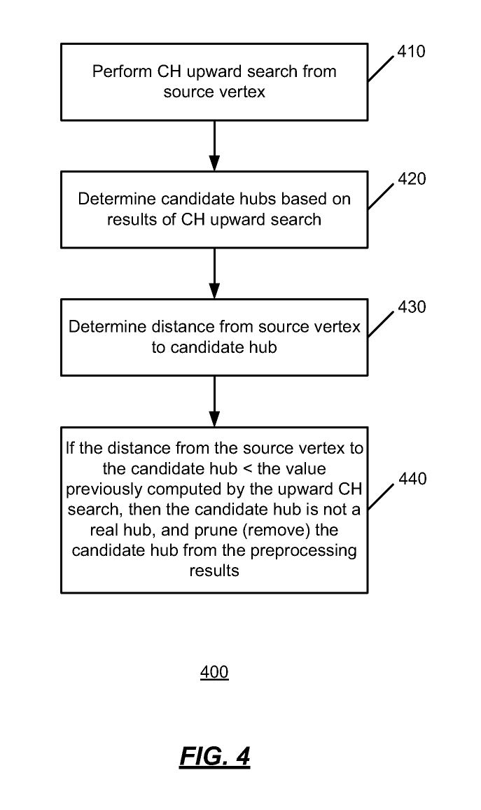

Label pruning involves identifying vertices visited by the CH search with incorrect distance bounds. FIG. 4 is an operational flow of an implementation of a method 400 for pruning labels in determining a shortest path between two locations. At 410, the normal CH upward search is performed from a vertex s. At 420, the candidate hubs are determined based on the results of the CH upward search. At 430, the distance from the source (e.g., the vertex s) to the candidate hub is determined. At 440, it is determined if that distance is less than the value previously computed by upward CH search, and if so, then it may be concluded that this candidate hub is not really a hub (i.e., is associated with an incorrect distance bound), so it is pruned (removed) from the preprocessing results. It has been found that most (e.g., about 80%) of the original nodes get pruned from the preprocessing results.

Partial pruning can be accomplished, for example, using a fast heuristic modification to the CH search. More particularly, suppose a forward CH search is being performed (the reverse case is similar) from vertex v, and vertex w is about to be scanned, with distance bound d(w). All incoming arcs (u,w)εA↓ are examined. If d(w)>d(u)+l(u,w), then d(w) is provably incorrect. The vertex w can be removed from the label, and outgoing arcs are not scanned from it. This technique increases the preprocessing time and decreases the average label size and query time.

Bootstrapping may be used to prune the labels further. Labels are computed in descending level order. Suppose the partially pruned label L_{f}(v) has been computed. It is known that d(v)=0 and that all other vertices w in L_{f}(v) have higher level than v, which means Lᵣ(w) has already been computed. Therefore, dist(v,w) can be computed by running a v-w query, using L_{f}(v) itself and the precomputed label Lᵣ(w). The vertex w is removed from L_{f}(v) if d(w)>dist(v,w). Bootstrapping reduces the average label size and reduces average query times.

Shortest path covers is an enhancement to the CH processing and may be used to determine which vertices are more important than other vertices. Vertices that appear in many shortest paths may tend to be more important than vertices that appear in fewer shortest paths. More particularly, the CH preprocessing algorithm tends to contract the least important vertices (those on few shortest paths) first, and the more important vertices (those on a greater number of shortest paths) later. The heuristic used to choose the next vertex to contract works poorly near the end of preprocessing, when it orders important vertices relative to one another. Shortest path covers may be used to improve the ordering of important vertices. This may be performed near the end of CH preprocessing, when most vertices have been contracted and the graph is small.

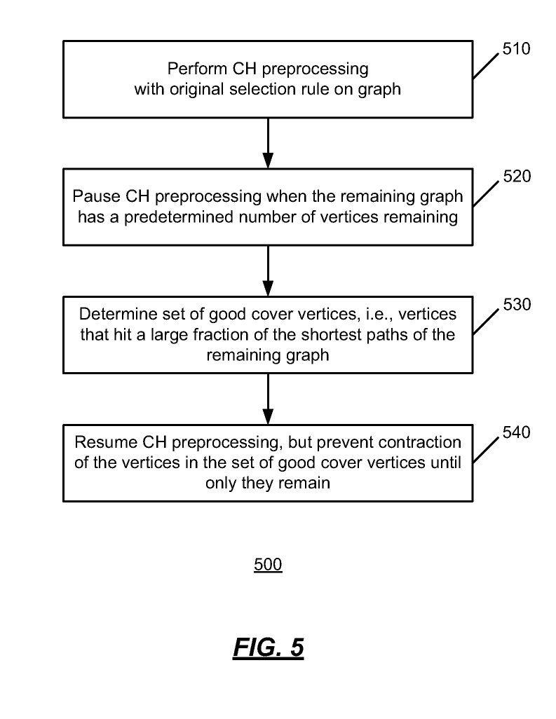

FIG. 5 is an operational flow of an implementation of a method 500 for using shortest path covers to reduce the average label size. At 510, the CH preprocessing is performed with the original selection rule, but it is paused at 520 as soon as the remaining graph Gₜ has only t vertices left (where t is a predetermined number, such as 500, 5000, 25000, etc., for example). Then, at 530, a greedy algorithm is run to find a set C of good cover vertices, i.e., vertices that hit a large fraction of all shortest paths of Gₜ, with |C|<t (e.g., |C|=2048, though any number may be used depending on the implementation). Starting with an empty set C, at each step add to C the vertex v that hits the most uncovered (by C) shortest paths in Gₜ. Once C has been computed, at 540, continue the CH preprocessing, but prevent the contraction of the vertices in C until they are the only ones left. This ensures the top |C| vertices of the hierarchy will be exactly the ones in C, which are then contracted in reverse greedy order (i.e., the first vertex found by the greedy algorithm is the last one remaining). This reduces the label size and the query times.

The preprocessing techniques described above may be improved. Labels are computed by the preprocessing set forth above. From the point of view of the database programmer, label computation is a black-box: as long as the labels obey the cover property, it does not matter how they are computed. However, label size affects query performance and storage requirements, and preprocessing time is to be reasonable. Techniques may be used that reduce preprocessing time (e.g., by two orders of magnitude), and can produce slightly better (smaller) labels.

As described above, hub label preprocessing comprises building the contraction hierarchy, finding appropriate shortest path covers (SPCs), and building the labels. The first stage is already fast, but its performance can be improved by increasing the amount of parallelism: finding an independent set of high-priority vertices and contracting them in parallel.

Acceleration of the other two stages of hub label preprocessing is now described. Hub label preprocessing uses a greedy algorithm to compute an SPC C of a graph Gₜ with t vertices. Starting from an empty set, in each round it adds to C the vertex that hits the most (yet-uncovered) shortest paths. Each round computes all-pairs shortest paths on Gₜ (running Dijkstra's algorithm t times) in order to find out which vertex should be picked next. An alternative implementation of this algorithm is described that can produce the same results much faster. Its efficiency also allows larger values of t to be used, which may improve label quality.

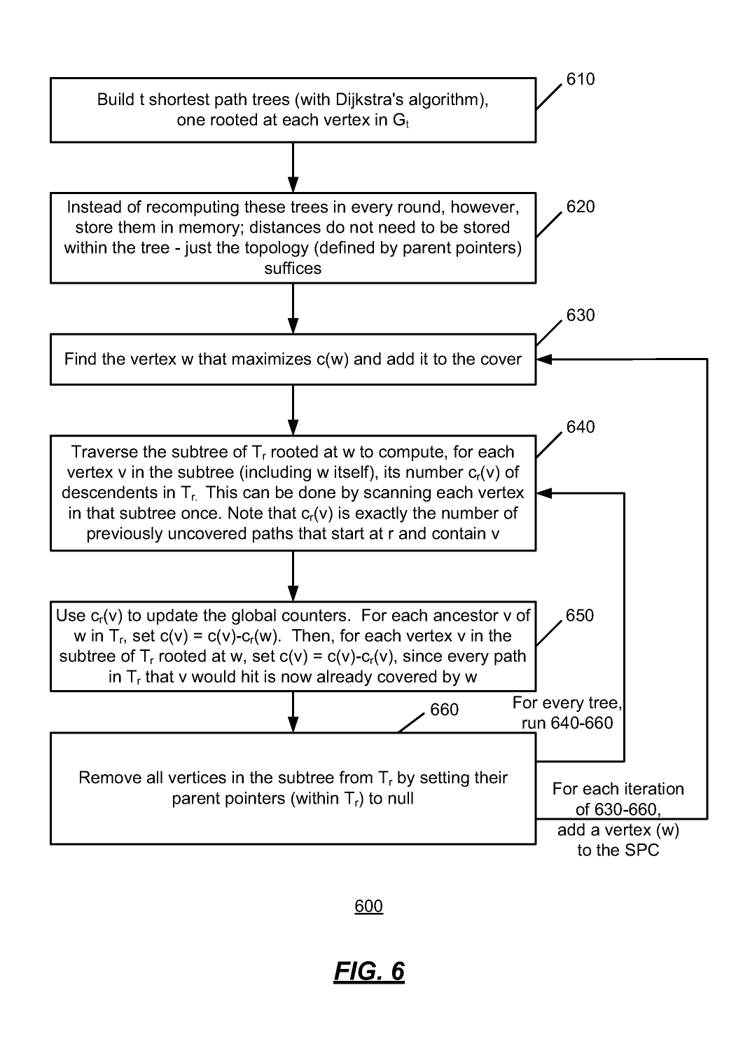

FIG. 6 is an operational flow of an implementation of a method 600 for computing shortest path covers, which may be used to accelerate hub label preprocessing. In an implementation, like the previous implementations, start at 610 by building t shortest path trees (with Dijkstra's algorithm), one rooted at each vertex in Gₜ. Instead of recomputing these trees in every round, however, store them in memory at 620. Distances do not need to be stored within the tree—just the topology (defined by parent pointers) suffices. The tree Tᵣ rooted at r may thus be represented as a single array where the i-th entry represents the parent of vertex I in the tree. A single matrix (comprising the concatenation of t such arrays) may be used to represent all uncovered shortest paths in the graph, eliminating the need to rerun Dijkstra's algorithm in subsequent rounds. This is not enough to make the algorithm much faster, however. Each round would still need to traverse the trees in full to determine the next vertex to add to the SPC. To avoid such traversals, each vertex v maintains a counter c(v) representing the number of yet-uncovered shortest paths that are hit by v. These counters are initialized when the shortest path trees are built, and only updated in subsequent rounds.

Each round works as follows. At 630, find the vertex w that maximizes c(w) and add it to the cover. Any path now covered by w will no longer contribute to the counter of any vertex v. To update the counters accordingly, look at each tree explicitly. Consider the tree Tᵣ rooted at some vertex r: it represents all uncovered shortest paths in Gₜ that start at r. Only paths in Tᵣ containing w are relevant during this round. To process them, at 640 traverse the subtree of Tᵣ rooted at w to compute, for each vertex v in the subtree (including w itself), its number cᵣ(v) of descendents in Tᵣ. (This can be done by scanning each vertex in that subtree once.) Note that cᵣ(v) is exactly the number of previously uncovered paths that start at r and contain v.

Now cᵣ(v) can be used to update the global counters at 650. For each ancestor v of w in Tᵣ, set c(v)=c(v)−cᵣ(w). Then, for each vertex v in the subtree of Tᵣ rooted at w, set c(v)=c(v)−cᵣ(v), since every path in Tᵣ that v would hit is now already covered by w. Accordingly, all vertices in the subtree are removed from Tᵣ by setting their parent pointers (within Tᵣ) to null at 660.

In an implementation, a parallel version of this algorithm can be used, in which each tree is processed independently in each round.

In another implementation, multiple visits to the same ancestor during a round can be avoided. Consider the round that adds w to the SPC. As before, when processing each tree Tᵣ, the amount cᵣ(w) is determined by which the c counters on the r-w path should be decremented. The union of these paths (over all r) is a tree. By traversing this tree appropriately, the cᵣ(w) values (for all r) can be used to update all c(v) counters in linear time.

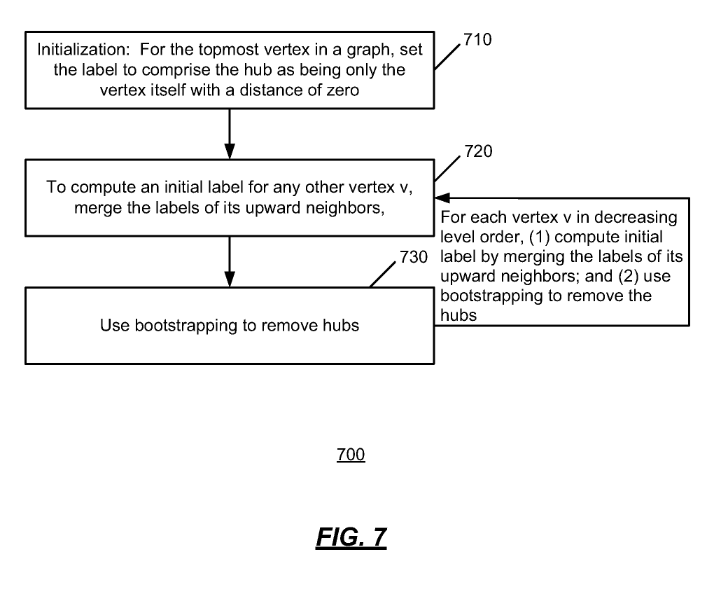

In an implementation, CH searches are eliminated altogether. Additionally, in an implementation, labels may be determined in decreasing level order. FIG. 7 is an operational flow of an implementation of a method 700 for accelerating hub label preprocessing using faster label generation. At 710, for the topmost vertex, the label is known in advance: its only hub is the vertex itself, with distance zero. To compute an initial label for any other vertex v, at 720, merge the labels of its upward neighbors, i.e., of all vertices w such that (v,w)εA↑. More precisely, initialize L_{f}(v) with (v,0) and then, for every pair (x, d_{w}(x))εL_{f}(w), add to L_{f}(v) a pair (x, d_{w}(x)+l(v,w)). If the same hub x appears in the labels of multiple neighbors w, keep the pair that minimizes d_{w}(x)+l(v,w). Since labels are sorted by hub ID, build the merged label by traversing all neighboring labels in tandem.

Once the initial L_{f}(v) label is built, bootstrapping may be used at 730 to remove hubs as described above. Note that bootstrapping is unnecessary for vertices that have exactly one neighbor. The labels of v's neighbors typically contain similar sets of hubs, which means their union is not much bigger than either of them. As an example, the average tentative label for the European road network has only two hubs removed by bootstrapping. For further speedups, this routine can be parallelized: all labels within a level can be computed independently.

Merging existing labels instead of running an upward CH search provides better locality and a smaller initial label (which speeds up bootstrapping). On continental road networks, the average time to generate initial labels is reduced by an order of magnitude, and the entire label generation procedure (including bootstrapping) becomes more than five times faster.

In an implementation, each label is maintained in RAM after it is computed, since the labels may be used for bootstrapping other labels. If memory is an issue, one can keep track of which labels are no longer needed, and output them to external memory sooner. To minimize the size of the working set in RAM, however, alternative label processing orders (instead of top-down by level) may be used. For example, the graph may be partitioned into compact regions, and each region is then processed in turn. If, when processing a vertex v, one of its upward neighbors w is in an unprocessed region, w is processed out of order.

Label compression may be performed to reduce the memory used by the technique. For example, if each vertex ID and distance is to be stored as a separate 32-bit integer, for low-ID vertices, an 8/24 compression scheme may be used: each of the first 256 vertices may be represented as a single 32-bit word, with 8 bits allocated to the ID and 24 bits to the distance. This technique may be generalized for different numbers of bits. For effectiveness, the vertices may be reordered so that the important ones (which appear in most labels) have the lowest IDs. (The new IDs, after reordering, are referred to as internal IDs.) This reduces the memory usage, and query times improve because of better locality.

Another compression technique exploits the fact that the forward (or reverse) CH trees of two nearby vertices in a road network are different near the roots, but are often the same when sufficiently away from them, where the most important vertices appear. By reordering vertices in reverse rank order, for example, the labels of nearby vertices will often share long common prefixes, with the same sets of vertices (but usually different distances). In an implementation, the compression technique may compute a dictionary of the common label prefixes and reuse them.

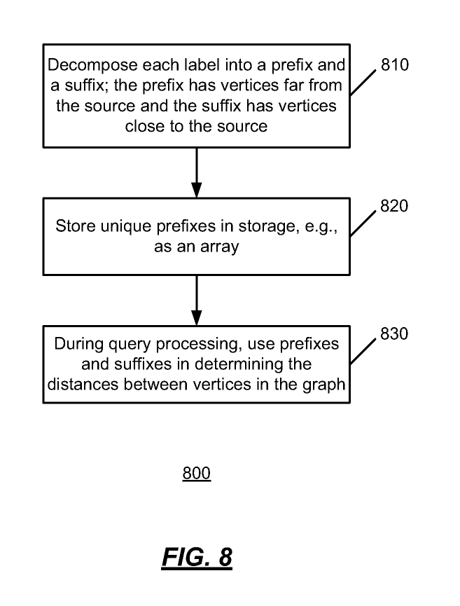

FIG. 8 is an operational flow of an implementation of a method 800 for label compression in determining a shortest path between two locations. At 810, each label is decomposed into a prefix and a suffix. The prefix is determined to contain the important vertices (which tend to be far from the source) and the suffix is determined to contain the less important (or unimportant) vertices (which tend to be close to the source). At 820, the unique prefixes may be stored in storage, e.g., as an array. Subsequently, at 830, during query processing, the prefixes and suffixes are used in determining the distances between vertices in the graph.

More particularly, given a parameter k, the k-prefix compression scheme decomposes each forward label L_{f}(v) (reverse labels are similar) into a prefix Pₖ(v) (with the vertices with internal ID lower than k) and a suffix Sₖ(v) (with the remaining vertices). Take the forward (pruned) CH search tree T_{y} from v: Sₖ(v) induces a subtree containing v (unless Sₖ(v) is empty), and Pₖ(v) induces a forest F. The base b(w) of a vertex wεPₖ(v) is the parent of the root of w's tree in F; by definition, b(w)εSₖ(v). If Sₖ(v) is empty, let b(v)=v. Each prefix Pₖ(v) is represented as a list of triples (w, δ(w), π(w)), where δ(w) is the distance between b(w) and w, and rt(w) is the position of b(w) in Sₖ(v). Two prefixes are equal only if they comprise the exact same triples. A dictionary (an array) may be built that comprises the distinct prefixes. Each triple may use 64 consecutive bits: 32 for the ID, 24 for δ(·), and 8 for π(·). A forward label L_{f} (v) comprises the position of its prefix Pₖ(v) in the dictionary, the number of vertices in the suffix Sₖ(v), and Sₖ(v) itself (represented as before). To save space, labels are not cache-aligned.

During a query from v, suppose w is in Pₖ(v). The distance dist(b(w),w)=δ(w) and the position π(w) of b(w) in Sₖ(v) is known, where dist(v,b(w)) is stored explicitly. The dist(v,w) may therefore be computed as=dist(v,b(w))+dist(b(w),w).

In an implementation, a flexible prefix compression scheme may be used. Instead of using the same threshold for all labels, it may split each label L in two arbitrarily. As before, common prefixes are represented once and shared among labels. To minimize the total space usage, including all n suffixes and the (up to n) prefixes that are kept, model this as a facility location problem. Each label is a customer that is represented (served) by a suitable prefix (facility). The opening cost of a facility is the size of the corresponding prefix. The cost of serving a customer L by a prefix P is the size of the corresponding suffix (|L|−|P|). Each label L is served by the available prefix that minimizes the service cost. Local search may be used to find a good heuristic solution.

Long range queries may be accelerated by a partition oracle. If the source and the target are far apart, the hub labeling technique searches tend to meet at very important (i.e., high rank) vertices. If the labels are rearranged such that more important vertices appear before less important ones, long-range queries can stop traversing the labels when sufficiently unimportant vertices are reached.

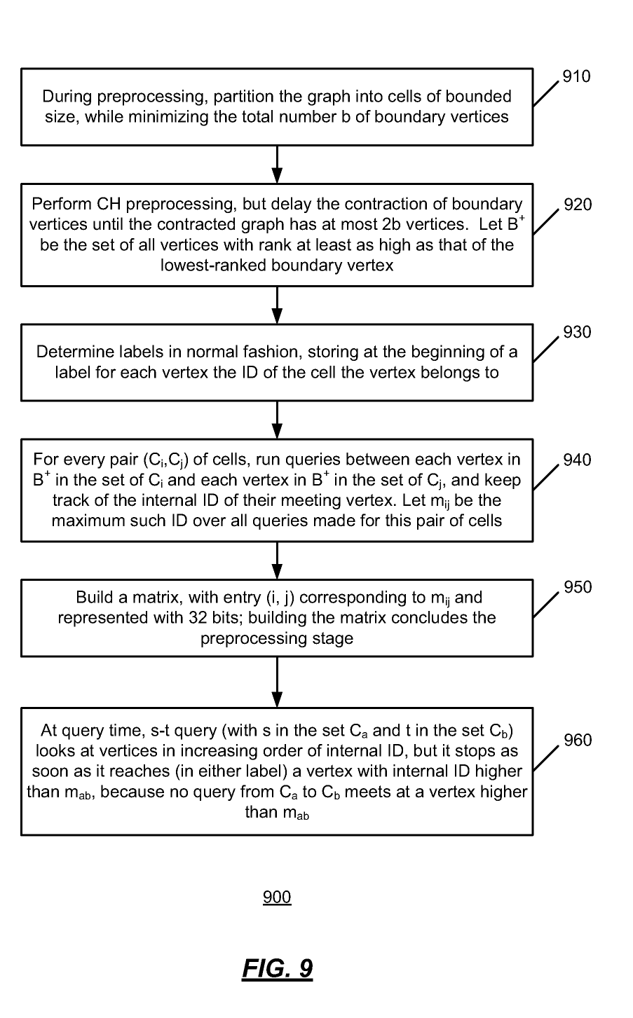

FIG. 9 is an operational flow of an implementation of a method 900 for accelerating queries using a partition oracle in determining a shortest path between two locations. During preprocessing at 910, the graph is partitioned into cells of bounded size, while minimizing the total number b of boundary vertices.

At 920, CH preprocessing is performed as usual, but the contraction of boundary vertices is delayed until the contracted graph has at most 2b vertices. Let B⁺ be the set of all vertices with rank at least as high as that of the lowest-ranked boundary vertex. This set includes all boundary vertices and has size |B⁺|≦b. At 930, labels are computed as set forth above, except the ID of the cell v belongs to is stored at the beginning of a label for v.

At 940, for every pair (Cᵢ,Cⱼ) of cells, queries are run between each vertex in B⁺∩Cᵢ and each vertex in B⁺∩Cⱼ, and the internal ID of their meeting vertex is maintained. Let mᵢⱼ be the maximum such ID over all queries made for this pair of cells. At 950, a matrix may be generated, with entry (i,j) corresponding to mᵢⱼ and represented with 32 bits in an implementation. The matrix has size k×k, where k is the number of cells. Building the matrix requires up to 4b² queries and concludes the preprocessing stage.

At 960, an s-t query (with sεCₐ and tεC_{b}) looks at vertices in increasing order of internal ID, but it stops as soon as it reaches (in either label) a vertex with internal ID higher than m_{ab}, because no query from Cₐ to C_{b} meets at a vertex higher than m_{ab}. Although this strategy needs one extra memory access to retrieve m_{ab}, long-range queries only look at a fraction of each label.

The techniques described above can be implemented using a database (such as the database 110 or the database 112 of FIG. 1), which has a number of advantages, including programmable SQL-type queries and getting efficient external memory implementation for free (i.e., supplied by the underlying database). In an implementation, the techniques described above (e.g., the hub based labeling techniques) may be implemented in SQL. Thus, shortest paths and nearest neighbors on road networks can be determined using relational databases. For example, relational operations (e.g., SQL) on data stored in a database are used to find paths on continental-sized networks in real time. As described further herein, point-to-point queries may use pure SQL, can handle continental road networks, and are guaranteed to find optimal paths. As an integral part of the database, they can be extended to handle more complicated scenarios than point-to-point queries.

Hub based labeling techniques use queries that are independent from preprocessing, and the queries can be stated in terms of set operations. In some implementations, hub based labeling queries use only relational database operators. A query comprises a set operation (pick the minimum element in the intersection of two sets), and can be naturally expressed in SQL. Techniques described herein can compute in real time not only exact distances, but also full descriptions of shortest paths. By storing the labels in a database, pure SQL code can be executed to obtain the distance between any two points, and to obtain a description of the corresponding shortest path. Such hub based labeling techniques can be extended to perform more sophisticated queries (such as nearest neighbors), taking advantage of the expressive power of relational databases. Additionally, a database implementation gives an external memory implementation of the underlying algorithm, enabling applications that use more information than fits in RAM.

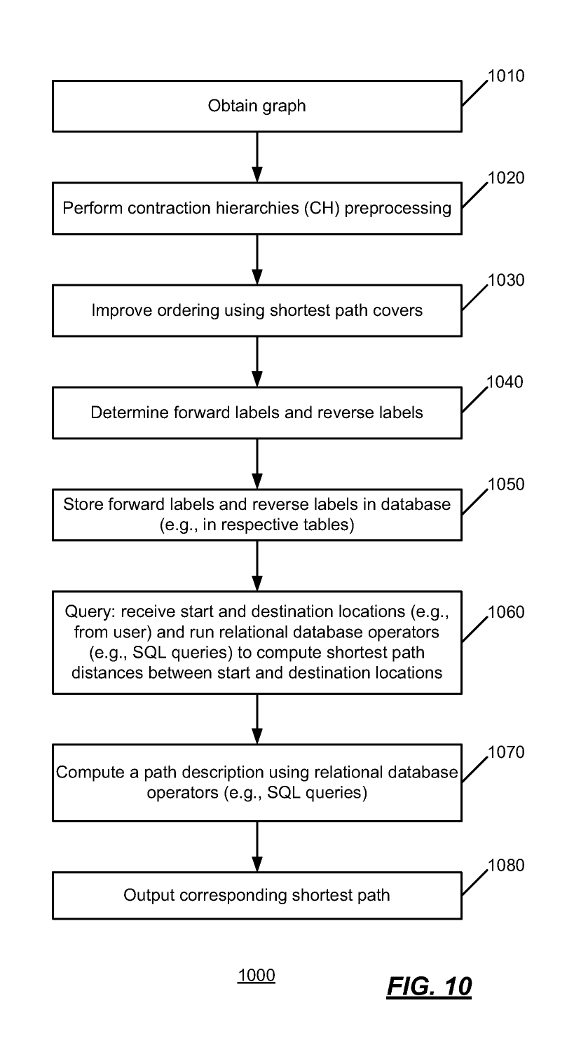

FIG. 10 is an operational flow of an implementation of a method 1000 using a hub based labeling technique with a relational database for determining a shortest path between two locations. Similar to the description of the method 300 above, in an implementation, the hub based labeling technique uses a preprocessing stage and a query stage. Finding the hubs is performed in the preprocessing stage, and finding the intersecting hubs (i.e., the common hubs shared by the source and the target) is performed in the query stage.

During the preprocessing stage, at 1010, a graph is obtained, e.g., from storage or from a user. At 1020, CH preprocessing is performed, and at 1030 the ordering may be improved using shortest path covers. Forward and reverse labels may then be determined at 1040, using techniques similar to those described above for example.

At 1050, the forward labels and the reverse labels may be stored in a database, such as the database 110 and/or the database 112. At query time, at 1060, queries, such as SQL queries, may be run to compute shortest path distances between user entered start and destination locations, for example. Then, at 1070, SQL queries may be run to compute a path description. The corresponding shortest path is outputted to the user at 1080.

In an implementation, the labels may be stored in the database in two tables, denoted herein the “forward” and “backward” tables. Each table contains all the labels of the corresponding direction, and has three columns: “node”, “hub”, and “dist”. Thus, for each vertex v, each pair (u, dist(v,u))εL_{f}(v) is stored as a triple (v, u, dist(v,u)) in the forward table. Similarly, the backward table stores a triple (v, u, dist(u,v)) for each (u, dist(u,v))εL_{b}(v).

In order to determine the distance between a source s and a target t, the shared hub of the source's entries in the forward table and the target's entries in the backward table are determined that minimizes the sum of the forward and backward distances.

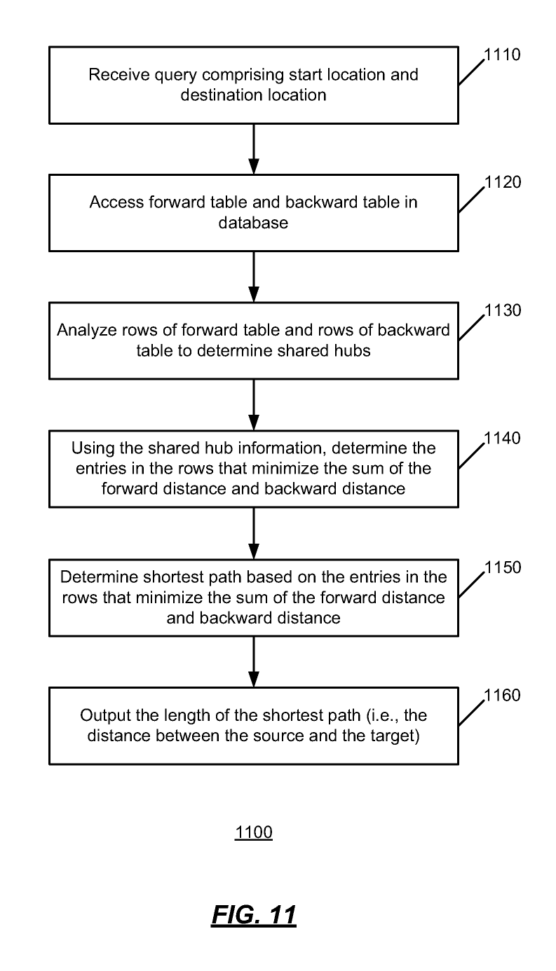

FIG. 11 is an operational flow of an implementation of a method 1100 using a hub based labeling technique with tables and a relational database for determining a distance between two locations. At 1110, a query is received comprising start and destination locations. At 1120, the forward table and the backward table are accessed in the database. At 1130, the rows of the forward table and the rows of the backward table are analyzed to determine shared hubs. At 1140, using the shared hub information, the entries in the rows that minimize the sum of the forward and backward distances are determined. The shortest path is determined from the results of 1150 and the length of the shortest path (i.e., the distance between the source and the target) is output at 1160.

The corresponding SQL statement may be added as a stored procedure to the database. The statement is a program that is run (i.e., executed) on the database. An example is provided as Algorithm 1:

Algorithm 1:

Input: source s ε V, target t ε V
1 SELECT
2 MIN(forward.dist+backward.dist)
3 FROM forward,backward
4 WHERE
5 forward.node = s AND
6 backward.node = t AND
7 forward.hub = backward.hub

Since the number of rows in the forward table and the backward table is huge (e.g., about 1.5 billion per table on the European road network), the tables should be indexed properly. Algorithm 1 needs fast access to the rows of source and target (lines 5 and 6), followed by fast access to specific hub entries (line 7) within these rows. Therefore, a composite clustered index may be built on node (primary) and hub (secondary). Note that all rows forming the label of a vertex should be stored together to reduce the number of random accesses to the database.

Algorithm 1 computes the distance between any two vertices s and t in the network. The actual list of arcs on the shortest s-t path P may be retrieved. The algorithms can be easily adapted to return the list of vertices as well.

For methods that use the notion of shortcuts, path retrieval works in two stages. First, the shortest s-t path P⁺ in G⁺ is obtained; each segment of P⁺ is either an original arc or a shortcut. This may be performed by maintaining parent pointers in G⁺ for each hub in each label. The number of such segments in P⁺ is usually very small—e.g., a few dozen on continental road networks. The second stage is path unpacking: find P by translating each shortcut in P⁺ into its constituent original arcs.

An approach is to use preassembled subpaths. During preprocessing, the entire sequence of arcs for each shortcut in the graph may be stored. Queries then are processed in two stages: first find the shortest s-t path P⁺ in G⁺, then translate each shortcut in P⁺ into the corresponding arcs. Unlike the recursive approach, the second step retrieves each shortcut path at once, reducing the total number of random accesses e.g., from thousands to dozens. This approach uses additional data proportional to the combined size of all shortcuts in the graph. Fortunately, on road networks each original arc belongs to only three to four shortcuts on average, so the space overhead is moderate.

The preassembled subpath approach may be extended by storing full descriptions of the paths between each vertex v and each of its hubs. If an s-t query meets at a hub v, concatenate the precomputed s-v and v-t paths to obtain the shortest path. The space requirements may become prohibitive, however (e.g., on the European road network, these paths have close to one trillion arcs in total). A more practical alternative would be an intermediate version that preassembles more than just shortcuts, but less than full paths. For example, paths from sufficiently important vertices to their hubs may be stored. As described further herein, the preassembled subpath approach (which precomputes all shortcuts descriptions) can be implemented within a relational database (e.g., using only SQL operations).

To support path retrieval, additional information may be precomputed and added to the database: assign a unique arc ID to every original arc, and a unique shortcut ID to every arc of A⁺ (which includes original arcs and shortcuts). Note that each original arc has both an arc ID and a shortcut ID, and they are not necessarily the same.

To translate individual shortcuts into their constituent arcs, a table “shortcuts” may be used that has three columns (sid, aid, aseq), where “aid” is the “aseq”-th arc on shortcut “sid”. A shortcut has one row in the shortcuts table for each arc it contains.

Additional fields may be used in each label. Extra columns are added to the forward table (in addition to node, hub, and dist): phub represents the parent hub (the predecessor of hub on the path from node in G⁺), and sid represents the ID of shortcut (or arc) from phub to hub. The backward table may be augmented in a similar way: phub represents the successor of hub on the path to node in G⁺, and sid represents the shortcut (or arc) from hub to phub. In both tables, phub and hub are undefined for rows where hub=node.

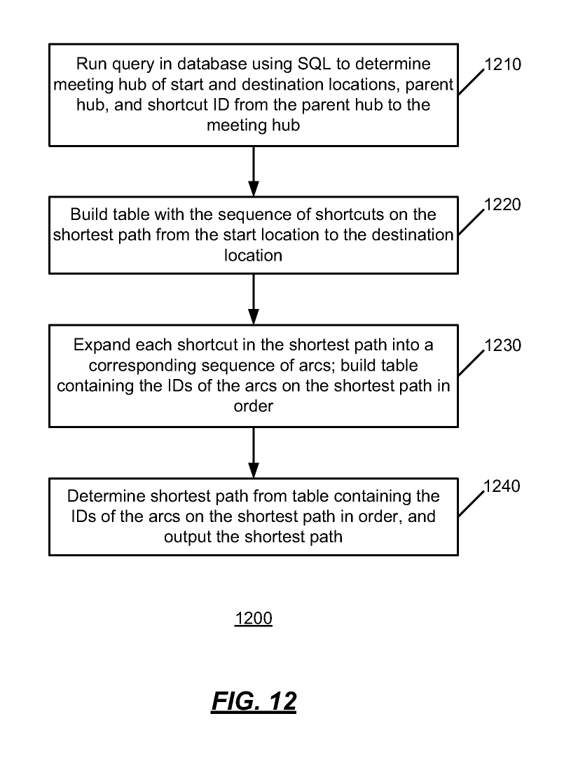

With these tables in place, an s-t query can be implemented in three stages, as described with respect to FIG. 12, for example. FIG. 12 is an operational flow of an implementation of a method 1200 using a hub based labeling technique using tables with a relational database for determining a shortest path between two locations.

At 1210, a query is run similar to Algorithm 1. Instead of finding just the meeting hub of the s-t path, however, it also returns the phub and sid fields in the corresponding rows of the forward table and the backward table.

At 1220, a temporary table “spath” is built with the sequence of shortcuts on the s-t path P⁺. Each row has two columns: sid represents a shortcut, and sseq is an integer indicating the relative order of this shortcut within P⁺. If shortcut sₐ appears before s_{b} in P⁺, the row representing sₐ has a lower sseq than the row representing s_{b}.

The spath table may be built one row at a time. Suppose x is the hub responsible for the s-t path. First, add to the spath table the shortcuts in the subpath of P⁺ between s and x by following parent pointers in L_{f}(v), represented by phub and sid in the forward table. This can be done in SQL with a WHILE loop. Since this will give shortcuts in reverse order, assign decreasing sseq values to them: −1, −2, −3, . . . . Then do the same for the shortcuts in the subpath of P⁺ between x and t. In this direction, following parent pointers provides the shortcuts in the right order, so increasing sseq values (e.g., 1, 2, 3, . . . ) are assigned to the shortcuts. Note that the shortcuts in the x-t subpath have higher sseq than the shortcuts in the s-x subpath.

At 1230, each individual shortcut in P⁺ is expanded into the corresponding sequence of arcs. This may be performed by joining spath (which was just computed) and shortcuts on column sid, ordering the resulting rows by sseq and aseq. The final table will contain the IDs of the arcs on the shortest s-t path in order. At 1240, the shortest path may be determined from the final table and outputted.

The label-based approach can be extended to enable a rich set of spatial queries. It can handle standard nearest neighbor queries (such as finding the closest gas station), as well as more sophisticated ones (such as finding the ten closest fast food restaurants that accept credit cards). Information describing potentially sophisticated subsets can be precomputed using the full expressiveness of SQL and stored in the database like regular labels. This enables efficient SQL implementations of both straightforward and sophisticated queries related to these precomputed subsets.

Embedding distance oracles within a database enables a rich set of features. Distances between any two vertices can be used within arbitrary SQL queries to filter or rank the output. In particular, with distance oracles points of interest (POI) (also known as nearest neighbor) queries can be implemented to find the k closest locations that satisfy a certain constraint. For example, one might want to find the k closest fast food restaurants that accept credit cards. Hub labels can be used as a black-box distance oracle, with the added benefit of being exact and more efficient.

The POI problem can be formulated as a variant of the one-to-many problem: find the shortest path between a source s and a preselected target set T (the POIs). It has been shown that, on road networks, one can do better than repeatedly calling a distance oracle for each element of T. The known bucket-based approach can quickly extract and rearrange information about T from the CH preprocessing data, leading to much faster queries.

It may be shown that the bucket-based approach, combined with hub labels, leads to faster algorithms. Furthermore, these algorithms can be implemented with relational database operators (e.g., SQL). An implementation using points of interest is provided herein as an example, along with two other applications: via points and ride sharing. More elaborate queries may also be implemented with the relational database operators.

Consider the scenario where a large number of queries (from different sources) is to be made using the same set of points of interest. This is the common “store locator” feature of many web sites (e.g., users need the closest branch of a coffee shop or the three closest ATMs of a particular bank). In such cases, extract from the backward table a table “poilab” containing only the relevant rows—those where node contains the POIs that are of interest. This can be done using a standard JOIN with the table representing the POIs, for example. Queries can now be run using the poilab table instead of the backward table, as shown in Algorithm 2:

Algorithm 2:

Input: source s ε V , number k
1 SELECT TOP k
2 MIN(forward.dist+poilab.dist) AS dist,
3 poilab.node
4 FROM forward, poilab
5 WHERE
6 forward.node = s AND
7 forward.hub = poilab.hub
8 GROUP BY poilab.node
9 ORDER BY dist

There are only minor differences relative to Algorithm 1, besides the use of the poilab table. The technique returns k distances, each with the POI responsible for it. The GROUP BY operator is used to make sure only the best hub is considered for each potential POI. Without it, multiple paths to the same POI may be returned using different hubs.

Because the poilab table is much smaller than the backward table, better locality is obtained. More locality may be obtained by indexing the poilab table by hub: this allows the query engine to skip rows containing hubs that do not appear in L_{f}(s) (the forward label of the source s).

The bucket-based approach does (outside databases) create a separate bucket for each hub in the (potentially large) target set, but queries only need to access buckets that represent hubs in the (much smaller) forward label. This approach was originally developed to solve the one-to-many problem: computing the shortest path from s to all points of interest in poilab. It can be solved with a variant of Algorithm 2 without the TOP k operator.

Having this algorithm within a database allows it to be modified to answer more involved queries. One can include more conditions in the WHERE operator of Algorithm 2, for example. For example, if poilab represents all restaurants, one can add a restriction that only those serving Italian food should be considered.

If the poilab table represents all acceptable points of interest with no additional constraints, queries can be accelerated further when k (the maximum number of points of interest a user may ask for) is known in advance. When building the poilab table, keep only the k rows with the smallest distance (“dist”) values for each distinct hub h. Additional rows cannot possibly be part of the final solution for any source s: among paths that use h, the first k entries dominate the others. If k is small relative to the number of POIs, removing the unnecessary rows speeds up the queries not only because it saves comparisons (for a given hub, fewer rows must be tested), but also by improving the locality of queries.

Additional improvements are possible for k=1, when it is desired to find the closest POI. Because each hub appears at most once in poilab, it may be made a primary key, eliminating the need for a clustered index and for the GROUP BY operator. In this case, one can think of poilab as a superlabel: this is a label one would obtain if all points of interest were conflated into a single vertex.

In essence, this single-hub indexing strategy is a translation into SQL of the bucked-based approach: it creates a separate bucket for each hub in the (potentially large) target set, but queries only need to access buckets that represent hubs in the (much smaller) forward label. This approach was first developed to solve the one-to-many problem: computing the shortest path from s to each element of a predefined set of targets (points of interest). It has recently been shown that this approach can be used (as an extension of CH) to solve the k-closest POI problem efficiently.

The POI queries can be extended to another problem involving via points, such as the best via point problem. In the best via point problem, one wants to go from s to t but wants to stop at another location (e.g., a post office) on the way from s to t. It is not mandatory that a stop is made at a particular location (e.g., which particular post office), but the overall travel time is to be minimized. So a determination is to be made which candidate location x minimizes dist(s,x)+dist(x,t). The best via point problem has numerous applications and can be solved using the techniques described herein.

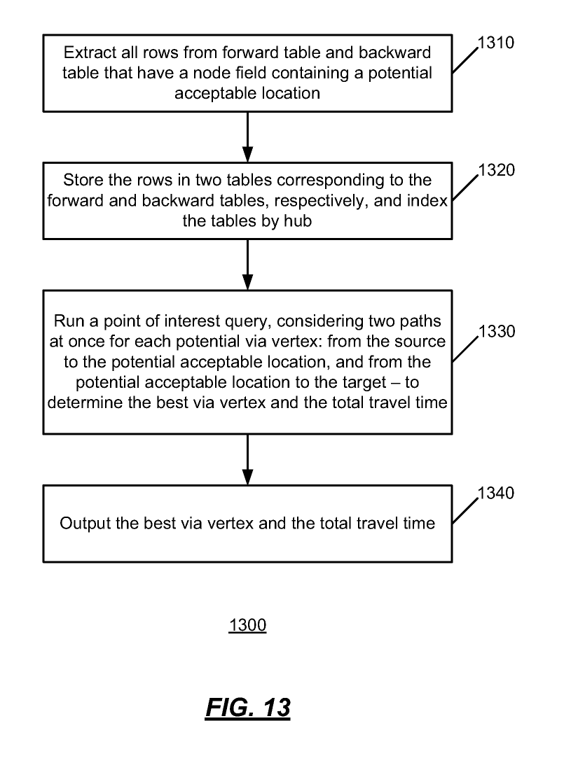

FIG. 13 is an operational flow of an implementation of a method 1300 using a hub based labeling technique with a relational database for determining a via point solution. At 1310, all rows from the forward table and the backward table are extracted where the node field contains the location x (i.e., a potential acceptable location, such as a post office in the example). At 1320, the rows are stored in two tables “vialabF” and “vialabB” corresponding to the forward and backward tables, respectively, and the vialabF and vialabB tables are indexed by hub.

At 1330, Algorithm 3 (below) is run, which is similar to a standard POI query, but considers two paths at once for each potential via vertex (POI) x: from the source to x and from x to the target. Algorithm 3 returns the best via vertex together with the total travel time. At 1340, the best via vertex and the total travel time may be outputted, e.g. to the user. To retrieve the best k via points, replace SELECT TOP 1 by SELECT TOP k, and add a GROUP BY vialabF.node statement.

Algorithm 3:

Input: source s ε V, target ε V
1 SELECT TOP 1
2 forward.dist + vialabB.dist
3 + vialabF.dist + backward.dist AS dist,
4 vialabB.node
5 FROM forward, vialabF, vialabB, backward
6 WHERE
7 forward.node = s AND
8 forward.hub = vialabB.hub AND
9 backward.hub = vialabF.hub AND
10 backward.node = t AND
11 vialabF.node = vialabB.node
12 ORDER BY dist

However, for location services that depend on a query source s, a query target t, and a set of predefined POIs P, single-hub indexing (such as that described above) is often not good enough. Again, for example, consider the best via point problem to travel from to t but with a stop at a post office on the way while minimizing the overall travel time. Formally, the post office p should be determined that minimizes dist(s,p)+dist(p,t). The straightforward approach is to run two external distance oracle queries (from s and to t) for each via point and report the one with the minimum sum. This yields a running time linear in |P|, the number of candidate via points. Similarly, the single-hub index techniques described above that use two tables “vialabF” and “vialabB” also have a running time that is linear in |P|, since all acceptable via points are considered.

Double-hub indexing, described herein, is asymptotically faster when |P| is large. Every path of interest is the concatenation of two shortest paths: from s to a POI p, then from the same POI p to t. The POI p (also referred to as a via vertex) is determined such that the total length is minimized, but without testing all candidates POIs explicitly. It is contemplated that the double-hub indexing techniques described herein can be used to handle any problem that involves computing two shortest paths with a common endpoint. The implementations described herein directed to via points, ride sharing, and POI prediction, for example, are merely examples of how the general double-hub indexing techniques may be used and are not meant to be limiting.

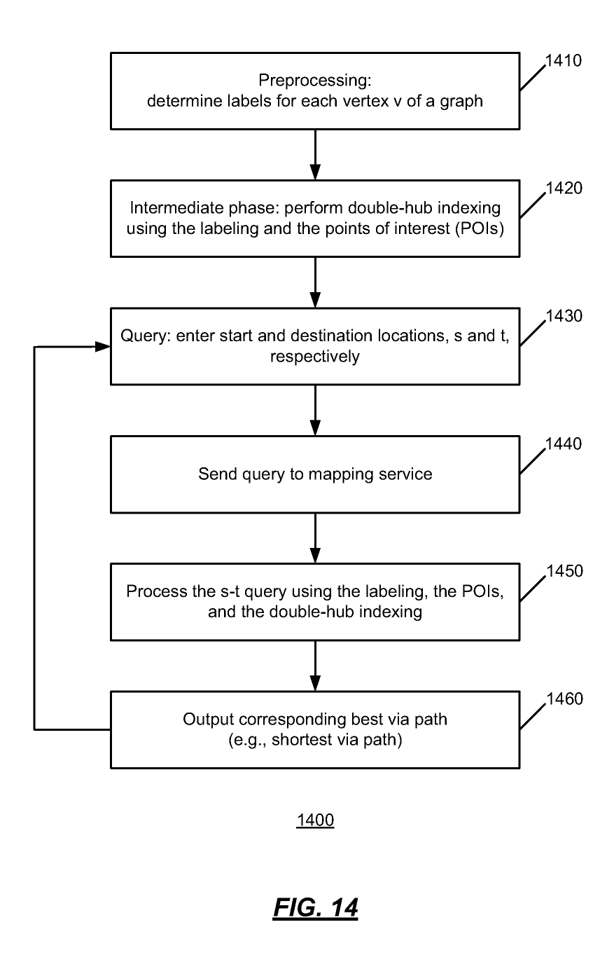

FIG. 14 is an operational flow of an implementation of a method 1400 using a double-hub indexing technique for determining a best via path (e.g., a shortest via path) between two locations. As noted above, a label for a vertex v is a set of hubs to which the vertex v stores a direct connection, and any two vertices s and t share at least one hub on the shortest s-t path.

During the preprocessing stage, at 1410, a labeling algorithm (described further herein) determines labels for each vertex v of a graph. At 1420, a second stage (which may be referred to as an intermediate phase) uses the labeling from 1410 and the points of interest (POIs) to perform double-hub indexing as described further herein. In this intermediate phase, labels of all the POIs are evaluated as set forth below.

At query time, at 1430, a user enters start and destination locations, s and t, respectively (e.g., using the computing device 100), and the query (e.g., the information pertaining to the s and t vertices) is sent to a mapping service (e.g., the map routing service 106) at 1440. The s-t query is processed at 1450 using the labeling, the POIs, and the double-hub indexing, as described further below. The corresponding path, using the best POI (i.e., best via point) is outputted to the user at 1460 as the best via path (e.g., the shortest via path). The path is the concatenation of two shortest paths, but may not be a shortest path by itself. FIG. 14 shows an arrow from 1460 back to 1430 to indicate that multiple queries can be run after a single execution of operations 1410 and 1420.

More particularly with respect to double-hub indexing, let p be a particular POI and let h be the meeting hub for path s-p and h′ be the meeting hub for p-t. Note that h is a forward hub for s and h′ is a backward hub for t. Additionally, both h and h′ are hubs of p (backward and forward, respectively). For a given s-t via query, therefore, it suffices to look at all pairs (h, h′) such that h is a forward hub for s and h′ a backward hub for t. To do so efficiently, precompute (before queries, during the intermediate phase) the POI p* for which dist(h,p*)+dist(p*,h′) is minimized (among all POIs that have both h and h′ as backward and forward hubs, respectively).

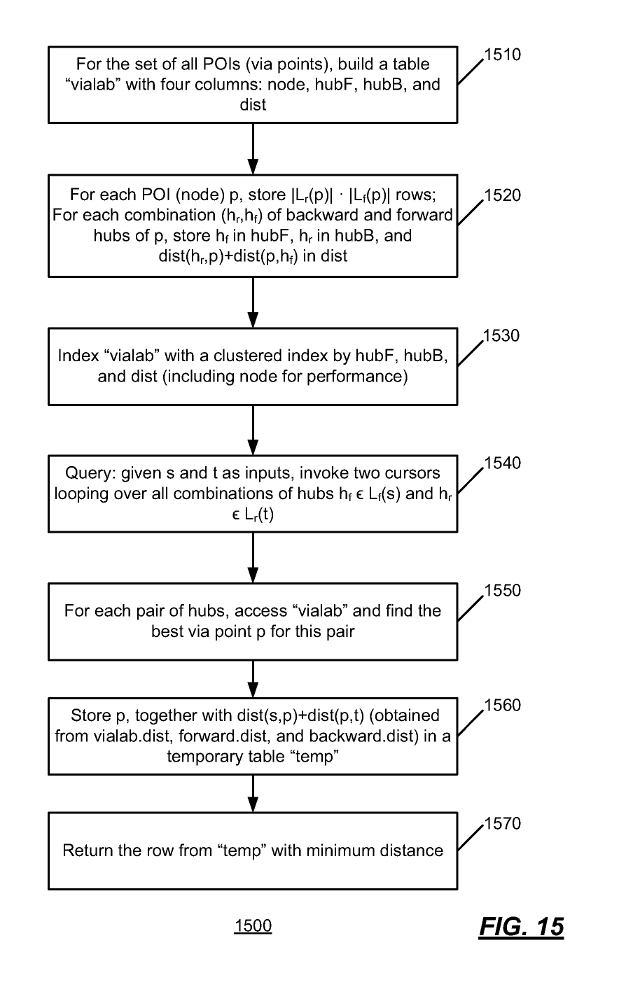

Such a technique may be implemented as described with respect to FIG. 15, which is an operational flow of another implementation of a method 1500 using a double-hub indexing technique for determining a best via path (e.g., a shortest via path) between two locations. At 1510, for the set of all POIs (via points), build a table called “vialab” with four columns: node, hubF, hubB, and dist. At 1520, for each POI (node) p, store |Lᵣ(p)|·|L_{f}(p)| rows. Thus, for each combination (hᵣ,h_{f}) of backward and forward hubs of p, store h_{f} in hubF, hᵣ in hubB, and dist(hᵣ,p)+dist(p,h_{f}) in dist. At 1530, index “vialab” with a clustered index by hubF, hubB, and dist (including node for performance). It is noted that although this example implementation is directed to a database (e.g., SQL) implementation, the double-hub indexing techniques may be implemented more directly as well (outside of a database implementation).

At query time, at 1540, given s and t as inputs, the query algorithm may loop over all combinations of hubs h_{f}εL_{f}(s) and hᵣεLᵣ(t). At 1550, for each pair of hubs, access “vialab” and find the best via point p for this pair (e.g., one that minimizes vialab.dist). At 1560, store p, together with dist(s,p)+dist(p,t) (which corresponds to the sum of vialab.dist, forward.dist, and backward.dist) in a temporary table called “temp”. After looping through the combinations, then at 1570, return the row from “temp” with minimum distance. With this double-hub indexing approach, query times depend on the square of the sizes of the labels, which can be considerably smaller than |P|.

This approach can be extended to finding the k best via nodes (and not just one). In the inner loop, return (and store in “temp”) the k best via points for the particular pair of hubs. Then, return the best k rows from “temp” with the additional constraint of grouping the result by the via point (this ensures at most one path is returned for each via point). The running time still depends on k and the square of the size of the labels, but not on the total number of available POIs.

The double-hub indexing techniques described herein can be used to solve the ride sharing problem, which tries to match queries (people looking for a ride from an origin to a destination t) to offers (drivers offering rides with origin s′ and destination t′). Given a new query, the goal is to find the offer that minimizes the (absolute) driver detour, given by dist(s′,s)+dist(s,t)+dist(t,t′)−dist(s′,t′).

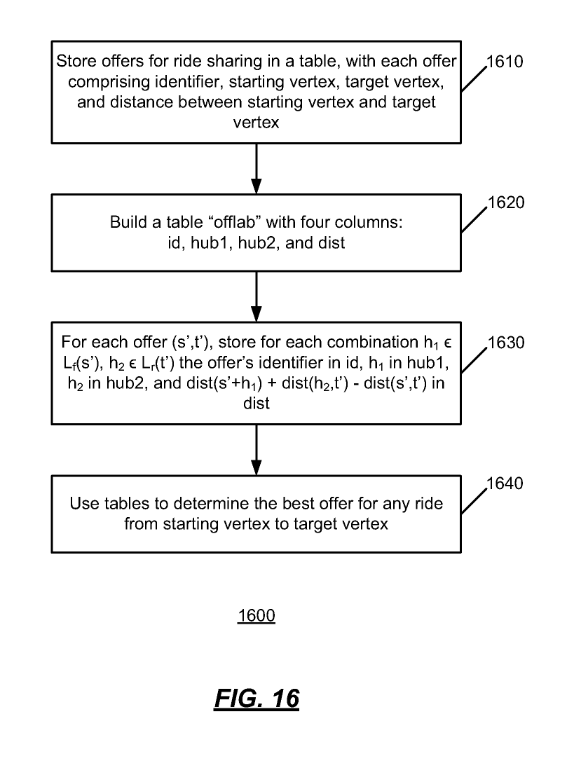

FIG. 16 is an operational flow of an implementation of a method 1600 using a double-hub indexing technique for determining a ride sharing solution. In an implementation, new queries may be immediately matched with current offers whenever possible. At 1610, all offers are stored in a table “offers” with four columns: id (a unique offer identifier), source (the starting vertex), target (the target vertex), and dist (the distance between starting and target vertex). Note that the distance can be computed when a new offer is provided into the “offers” table.

Similar to the via point application, at 1620, build a table “offlab” similar to “vialab”, with four columns: id, hub1, hub2, and dist. At 1630, for each offer (s′,t′), store for each combination h₁εL_{f}(s′), h₂εL_{b}(t′) the offer's identifier in id, h₁ in hub1, h₂ in hub2, and dist(s′,h₁)+dist(h₂,t′)−dist(s′,t′) in dist.

These tables may be used to determine the best offer for any ride (s,t) at 1640, which then may be outputted (e.g., to a user). The query algorithm for a pair (s,t) works as in the via node problem described with respect to FIG. 15 for example, with two cursors looping over each combination h₁εL_{b}(S), h₂εL_{f}(t). It is desired to pick the pair (h₁,h₂) that minimizes dist(h₁,s)+offlab.dist(h₁,h₂)+dist(t,h₂). Again, query times depend only on the number of hubs in s and t. This approach can be extended to include additional constraints, such as departure time, number of passengers, or amount of cargo. All it needs to do is exclude from consideration rows corresponding to drivers that do not satisfy the additional constraints.

Another application of double-hub indexing is POI prediction. Often a user knows his way and does not enter a destination into his navigation system. While driving, however, he may decide to stop for gas or another service, for example. Intuitively, if he asks the system for a nearby gas station, the best answer may not be the closest one, since it could actually be behind the user. This motivates the need for POI prediction, i.e., reporting a reasonable POI that is “ahead” of the user, even if his final destination is unknown.

Formally, consider the following problem. Suppose the user is at vertex v, and has traveled for some time on a shortest u-v path (which has been tracked by the system), and asks for k POIs that are close and “on the way”. POIs may be determined that are close to v (closeness criterion) and such that the path from u to the POI via v is not much longer than the shortest path from u to the POI (detour criterion).

In an implementation, assign a score S(p)=dist(u,v)+(1+ε)dist(v,p)−dist(u,p) to each POI, and report the k POIs with the smallest S(p) values. One can interpret S(p) as the sum of two terms. The dist(u,v)+dist(v,p)−dist(u,p) term is the length of the detour one makes by going from u to p through v. The ε·dist(v,p) term is proportional to the distance from v to p. The value of ε is chosen to achieve the desired balance between detour length and closeness and may vary with the type of POI. Thus, if ε is relatively large, then a close POI is preferred, and if ε is relatively small, then closeness of the POI is not as important as the amount of detour. For example, closeness may be more important for finding the nearest restroom than the nearest post office, so in the former case ε is bigger. It is contemplated that other score functions (e.g., that are a function of dist(u,v) and dist(v,p) and dist (u,p)) can be implemented using a double-hub indexing strategy.

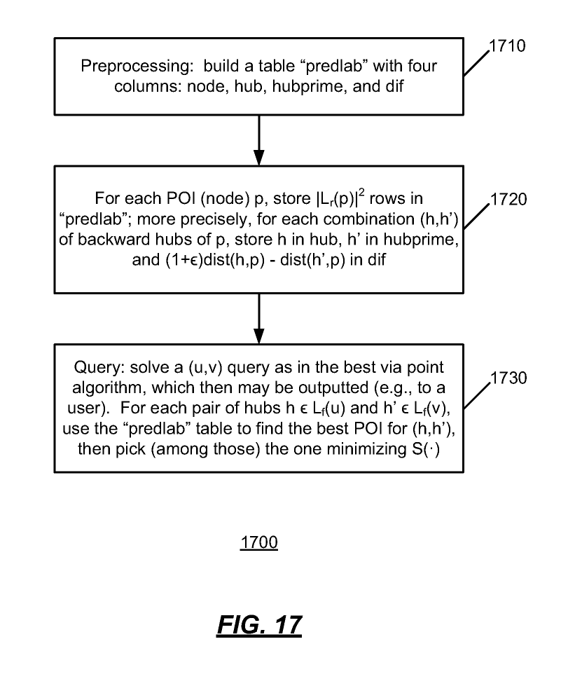

FIG. 17 is an operational flow of an implementation of a method 1700 using a double-hub indexing technique for POI prediction. An implementation computes S(·) for all POIs and has running time linear in |P|. If E is predefined (e.g., 0.05), double-hub indexing gives a more efficient solution. Also, note that dist(u,v) can be removed from S(p), since it is the same for all POIs. It suffices to evaluate S(p)=(1+ε)dist(v,p)−dist(u,p) for each POI p.

To do so efficiently, at 1710, use a preprocessing stage to build a table “predlab” with four columns: node, hub, hubprime, and dif. At 1720, for each POI (node) p, store |Lᵣ(p)|² rows in “predlab”; more precisely, for each combination (h,h′) of backward hubs of p, store h in hub, h′ in hubprime, and (1+ε)dist(h,p)−dist(h′,p) in dif.

At 1730, at query time, a (u,v) query then is solved as in the best via point algorithm described above (e.g., with respect to FIG. 15), which then may be outputted (e.g., to a user). For each pair of hubs hεL_{f}(u) and h′εL_{f}(v), use the “predlab” table to find the best POI for (h,h′), then pick (among those) the one minimizing S(·). Any other ranking function may be used that depends only on the lengths of the paths between u, v, and p.

The techniques described above can be implemented using a database (such as the database 110 or the database 112 of FIG. 1). In an implementation, the techniques described above (e.g., the double-hub indexing techniques) may be implemented in SQL. Thus, shortest paths and nearest neighbors on road networks can be determined using relational databases. For example, relational operations (e.g., SQL) on data stored in a database are used to find paths on continental-sized networks in real time. As described further herein, point-to-point queries may use pure SQL, can handle continental road networks, and are guaranteed to find optimal paths. As an integral part of the database, they can be extended to handle more complicated scenarios than point-to-point queries. It is contemplated that in other implementations, the double-hub indexing techniques may be performed, used, and/or implemented outside a database.

FIG. 18 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, PCs, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 18, an exemplary system for implementing aspects described herein includes a computing device, such as computing device 1800. In its most basic configuration, computing device 1800 typically includes at least one processing unit 1802 and memory 1804. Depending on the exact configuration and type of computing device, memory 1804 may be volatile (such as random access memory (RAM)), non-volatile (such as read-only memory (ROM), flash memory, etc.), or some combination of the two. This most basic configuration is illustrated in FIG. 18 by dashed line 1806.

Computing device 1800 may have additional features/functionality. For example, computing device 1800 may include additional storage (removable and/or non-removable) including, but not limited to, magnetic or optical disks or tape. Such additional storage is illustrated in FIG. 18 by removable storage 1808 and non-removable storage 1810.

Computing device 1800 typically includes a variety of computer readable media. Computer readable media can be any available media that can be accessed by computing device 1800 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 1804, removable storage 1808, and non-removable storage 1810 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1800. Any such computer storage media may be part of computing device 1800.

Computing device 1800 may contain communications connection(s) 1812 that allow the device to communicate with other devices. Computing device 1800 may also have input device(s) 1814 such as a keyboard, mouse, pen, voice input device, touch input device, etc. Output device(s) 1816 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of determining a path between two locations, comprising:
receiving as input, at a computing device, a graph comprising a plurality of vertices and arcs;
generating a plurality of labels for each vertex of the graph wherein for each vertex, the label comprises a set of vertices referred to as hubs and the distances between the hubs in the label and the vertex; and
performing double-hub indexing using the labels and a plurality of via points on the graph.

2. The method of claim 1, wherein the plurality of via points comprise a plurality of points of interest.

3. The method of claim 1, further comprising storing data corresponding to the vertices and labels as preprocessed graph data in a storage associated with the computing device.

4. The method of claim 1, wherein the method is implemented for a SQL query.

5. The method of claim 4, wherein the SQL query comprises a point-to-point shortest path query.

6. The method of claim 4, wherein the SQL query comprises a point of interest query.

7. The method of claim 1, wherein the plurality of labels for each vertex of the graph comprises a forward label and a reverse label, wherein the forward label comprises the set of vertices referred to as forward hubs and the distances from the vertex to each forward hub, and wherein the reverse label comprises the set of vertices referred to as reverse hubs and the distances from each reverse hub to the vertex, and further comprising:
storing the forward labels and the reverse labels in tables in the relational database.

8. The method of claim 7, wherein the double-hub indexing comprises:
determining a shortest path from a start location to a via point using the hubs in a label for the via point; and
determining a shortest path from the via point to a destination location using the hubs in the label for the via point.

9. The method of claim 1, wherein the graph represents a network of nodes.

10. The method of claim 1, wherein the graph represents a road map.

11. A method of determining a path between two locations, comprising:
preprocessing, at a computing device, a graph comprising a plurality of vertices to generate preprocessed data comprising a plurality of labels for each vertex of the graph, wherein for each vertex, each label comprises a set of vertices and the distances between the vertices in the set of vertices and the vertex;
performing double-hub indexing using the labels and a plurality of via points on the graph;
storing the results of the double-hub indexing in storage of the computing device;
receiving a query at the computing device;
determining a source vertex and a destination vertex based on the query, by the computing device;
performing a path computation on the preprocessed data and the results of the double-hub indexing with respect to the source vertex and the destination vertex to determine a path between the source vertex and the destination vertex; and
outputting the path, by the computing device.

12. The method of claim 11, wherein performing the path computation comprises performing a shortest via path computation.

13. The method of claim 11, wherein performing the path computation comprises performing a ride sharing computation.

14. The method of claim 11, wherein performing the path computation comprises performing a point of interest prediction.

15. The method of claim 11, wherein the double-hub indexing comprises:
determining a shortest path from the source vertex to a via point using the hubs in a label for the via point; and
determining a shortest path from the via point to a destination vertex using the hubs in the label for the via point.

16. A method of determining a path between two locations, comprising:
receiving as input at a computing device, preprocessed graph data representing a graph comprising a plurality of vertices, wherein the preprocessed data corresponds to the vertices and a plurality of labels for each vertex of the graph, wherein the plurality of labels for each vertex of the graph comprises a forward label and a reverse label, wherein the forward label comprises the set of vertices and the distances to the vertices in the set of vertices from each vertex, and wherein the reverse label comprises the set of vertices and the distances from the vertices in the set of vertices to each vertex;
performing, using double-hub indexing, a path computation on the preprocessed data with respect to a source vertex and a destination vertex to determine a path between the source vertex and the destination vertex; and
outputting the shortest path, by the computing device.

17. The method of claim 16, wherein the input is received at a relational database associated with the computing device, and wherein the double-hub indexing is performed using SQL statements in the relational database.

18. The method of claim 16, wherein the path computation comprises a point-to-point shortest path computation.

19. The method of claim 16, wherein the path computation comprises a point of interest computation.

20. The method of claim 16, wherein the path computation comprises a via point computation.
